(19) United States
(12) Patent Application Publication
(10) Pub. No.: US 2011/0310969 A1
(43) Pub. Date: Dec. 22, 2011

(54) METHOD AND APPARATUS FOR IMAGE INTRA PREDICTION AND IMAGE DECODING METHOD AND APPARATUS USING THE SAME

(75) Inventors: Young-o PARK, Seoul (KR); Kwan-woong SONG, Seongnam-si (KR); Young-hun JOO, Yongin-si (KR); Sung-jae KO, Seoul (KR); Hyung-min NAM, Seoul (KR); Jae-yun JUNG, Seoul (KR)

(73) Assignee: SAMSUNG ELECTRONICS CO., LTD., Suwon-si (KR)

(21) Appl. No.: 13/052,186

(22) Filed: Mar. 21, 2011

(30) Foreign Application Priority Data
Jun. 18, 2010 (KR) 10-2010-0058228

(51) Int. Cl. H04N 7/28; H04N 7/32

(52) U.S. Cl. 375/240.16; 375/240.12; 375/E07.027; 375/E07.104; 375/E07.246

(57) ABSTRACT

An image intra prediction method and image intra prediction apparatus and a decoding apparatus and a decoding method using the image intra prediction method are provided. The image intra prediction method includes: backing up boundary pixel values adjacent to a block that is to be decoded; correcting the boundary pixel values adjacent to the block that is to be decoded based on correlations between the boundary pixels and pixels adjacent to the boundary pixels; predicting a block that is to be decoded according to an intra mode, from among a plurality of intra modes, based on the corrected boundary pixel values; and restoring the boundary pixel values from the backed-up values.

### CROSS-REFERENCE TO RELATED PATENT APPLICATION

This application claims priority from Korean Patent Application No. 10-2010-0058228, filed on Jun. 18, 2010 in the Korean Intellectual Property Office, the disclosure of which is incorporated herein in its entirety by reference.

### BACKGROUND

1. Field

Apparatuses and methods consistent with exemplary embodiments relate to an image data decoding system, and more particularly, to an image intra prediction method and an image intra prediction apparatus in an image decoder for supporting a downsized image, and an image decoding method and an image decoding apparatus using the image intra prediction method and the image intra prediction apparatus.

2. Description of the Related Art

In general, it is possible to enjoy a high quality image by using a small capacity of a high performance image compression codec, such as MPEG-4, H/264, etc. However, since the high quality image has a high decoding complexity, a low performance personal computer (PC) or mobile device may have a problem in decoding the high quality image. Further, the smaller the size of a display device for outputting an image, such as the mobile device, the more the image must be resized in accordance with the size of the display device. Thus, in general, an embedded scaling (ES) technology of performing a resizing operation during an image decoding process is used to reduce an amount of redundant calculations of image decoding and resizing.

The ES technology performs the resizing operation during the image decoding process according to a variety of video compression standards (for example, MPEG-2, MPEG-4, and H/264), thereby reducing a complexity of a decoding module and resolution of an image. The ES technology corrects a motion compensation (MC) and an inverse discrete cosine transform (IDCT) having a high decoding complexity.

For example, the ES technology corrects the MC so as to generate a prediction image of a low resolution downsized by using a motion vector (MV), thereby reducing a complexity of an MC module. Further, the ES technology corrects the IDCT so as to generate a differential image of a low resolution from DCT coefficients, thereby reducing a complexity of an IDCT module. Therefore, a decoder can restore an image of a low resolution by combining the prediction image and the differential image by using the MC module and the IDCT module having a low complexity.

The H.264/Advanced video coding (AVC) provides an intra prediction operation that is not provided by the related art compression standards.

In general, the intra prediction operation of the H.264/AVC provides a variety of prediction modes for prediction-coding a block in a frame by using only information in the identical frame. The prediction process performs an important role in increasing compression efficiency of the H.264/AVC.

In the H.264/AVC, the intra prediction operation is a core operation for increasing a compression ratio and occupies a major portion of a decoding complexity. Thus, an intra prediction technology is realized in the ES technology so as to apply the H.264/AVC to the ES technology. However, if a method provided by the H.264/AVC standard is used to apply intra prediction to the ES technology, image quality seriously deteriorates.

### SUMMARY

One or more exemplary embodiments provide an image intra prediction method and an image intra prediction apparatus by which a compression decoder for supporting an embedded scaling (ES) operation efficiently performs intra prediction.

One or more exemplary embodiments also provide an image decoding method and an image decoding apparatus using the image intra prediction method and the image intra prediction apparatus.

According to an aspect of an exemplary embodiment, there is provided an image intra prediction method including: backing up values of boundary pixels adjacent to a block that is to be decoded; correcting the values of the boundary pixels adjacent to the block that is to be decoded based on correlations between the boundary pixels and pixels adjacent to the boundary pixels; predicting the block that is to be decoded according to an intra mode, from among a plurality of intra modes, based on the corrected values of the boundary pixels; and restoring the values of the boundary pixels from the backed-up values.

The correcting the values of the boundary pixels may include: comparing the boundary pixels with the pixels adjacent to the boundary pixels; and adjusting the values of the boundary pixels according to a result of the comparison.

The adjusting the values of the boundary pixels may include: obtaining differences between the boundary pixels and the pixels adjacent to the boundary pixels; if the obtained differences between the boundary pixels and the pixels adjacent to the boundary pixels are greater than a threshold value, adjusting the values of the boundary pixels; and if the obtained differences between the boundary pixels and the pixels adjacent to the boundary pixels are smaller than the threshold value, maintaining the values of the boundary pixels.

The predicting the block that is to be decoded may include: predicting pixel values down-scaled for the intra mode by using the corrected values of the boundary pixels.

The predicting the block that is to be decoded may include: predicting pixel values by using a standard compression method when the intra mode is a DC mode, a horizontal mode, and a vertical mode, and predicting the pixel values by using an average of the pixel values predicted by using the standard compression method when the intra mode is a diagonal left/right mode, a vertical left/right mode, and a horizontal left/right mode.

The restoring the values of the boundary pixels may include replacing the corrected values of the boundary pixels with the backed up values.

The values of the boundary pixels may be down-scaled pixel values.

The image intra prediction may be performed by a compression decoder for supporting an embedded scaling (ES) operation.

According to an aspect of another exemplary embodiment, there is provided an image decoding method including: generating residual block information, a motion vector (MV), and prediction mode information by entropy-decoding a bit stream; extracting residual block coefficients by inversely quantizing the generated residual block information; down-scaling the generated residual block coefficients; performing intra prediction scaled based on corrected values of boundary pixels adjacent to a block that is to be decoded, corrected by using correlations between the boundary pixels and pixels adjacent to the boundary pixels; and generating an image signal reconstructed by adding a residual signal generated by the down-scaling to an intra prediction signal generated by the performing the intra prediction.

The performing the intra prediction may include predicting the block that is to be decoded according to an intra mode, from among a plurality of intra modes, based on the corrected values of the boundary pixels.

According to an aspect of another exemplary embodiment, there is provided an image intra prediction apparatus including: an image backup unit which backs up values of boundary pixels adjacent to a block that is to be decoded; an extrapolation unit which corrects the values of the boundary pixels of the block that is to be decoded based on correlations between the boundary pixels adjacent to the block that is to be decoded and pixels adjacent to the boundary pixels; an interpolation unit which predicts a block that is to be decoded according to an intra mode, from among a plurality of intra modes, based on the corrected values of the boundary pixels; and an image restoration unit which replaces the corrected values of the boundary pixels with the backed up values of the boundary pixels.

According to an aspect of another exemplary embodiment, there is provided an image decoding apparatus including: an entropy decoding unit which generates residual block information, an MV, and prediction mode information by entropy-decoding a bit stream; an inverse-quantization unit which extracts residual block coefficients by inversely quantizing the residual block information generated by the entropy decoding unit; a residual down-sizing unit which down-scales the generated residual block coefficients generated by the inverse-quantization unit; an image prediction unit which performs intra prediction scaled based on values of boundary pixels adjacent to a block that is to be decoded corrected by using correlations between the boundary pixels and pixels adjacent to the boundary pixels; and an adding unit which reconstructs an image signal by adding a residual signal generated by the residual down-sizing unit to an intra prediction signal generated by the image prediction unit.

The image prediction unit may include: an image backup unit which backs up values of the boundary pixels adjacent to the block that is to be decoded; an extrapolation unit which corrects the values of the boundary pixels adjacent to the block that is to be decoded based on correlations between the boundary pixels and the pixels adjacent to the boundary pixels; an interpolation unit which predicts the block that is to be decoded according to an intra mode, from among a plurality of intra modes, based on the corrected values of the boundary pixels; and an image restoration unit which replaces the corrected values of the boundary pixels with the backed-up values.

According to an aspect of another exemplary embodiment, there is provided an image intra prediction method including: obtaining corrected values of boundary pixels adjacent to a block that is to be decoded, the corrected values being based on correlations between the boundary pixels and pixels adjacent to the boundary pixels, outside of the block that is to be decoded; and predicting the block that is to be decoded according to an intra mode, from among a plurality of intra modes, based on the obtained corrected values.

### BRIEF DESCRIPTION OF THE DRAWINGS

The above and other aspects will become more apparent by describing in detail exemplary embodiments with reference to the attached drawings in which:

FIG. 1 is a block diagram of an image decoding apparatus according to an exemplary embodiment;

FIG. 2 is detailed block diagram of a scaled intra prediction unit of FIG. 1;

FIG. 3 illustrates a motion compensation (MC) performed by a scaled MC unit of FIG. 1;

FIG. 4 is a flowchart illustrating an image intra prediction method according to an exemplary embodiment;

FIG. 5 illustrates an intra prediction method proposed by a related art H.264 standard;

FIGS. 6A and 6B illustrate a comparison of intra prediction performed by a related art H.264 encoder and intra prediction performed by a related art H.264 decoder with embedded scaling (ES);

FIG. 7 illustrates an extrapolation for adjusting values of boundary pixels used to perform intra prediction according to an exemplary embodiment;

FIGS. 8A and 8B illustrate a comparison of intra prediction performed by a related art H.264 encoder and intra prediction performed by a related art H.264 decoder with ES;

FIGS. 9A through 9I illustrate prediction directions for intra modes according to an exemplary embodiment;

FIGS. 10A and 10B illustrate a comparison of a value obtained by using an 264 intra prediction method with ES and a down-scaled value obtained by performing intra prediction in a block of an original size during intra prediction in a diagonal down-right prediction mode;

FIG. 11 is a detailed flowchart illustrating a method of correcting values of boundary pixels of a block that is to be decoded according to an exemplary embodiment; and

FIG. 12 is a flowchart illustrating an image decoding method according to an exemplary embodiment.

### DETAILED DESCRIPTION OF EXEMPLARY EMBODIMENTS

Exemplary embodiments will now be described more fully with reference to the accompanying drawings, in which like reference numerals refer to like elements throughout.

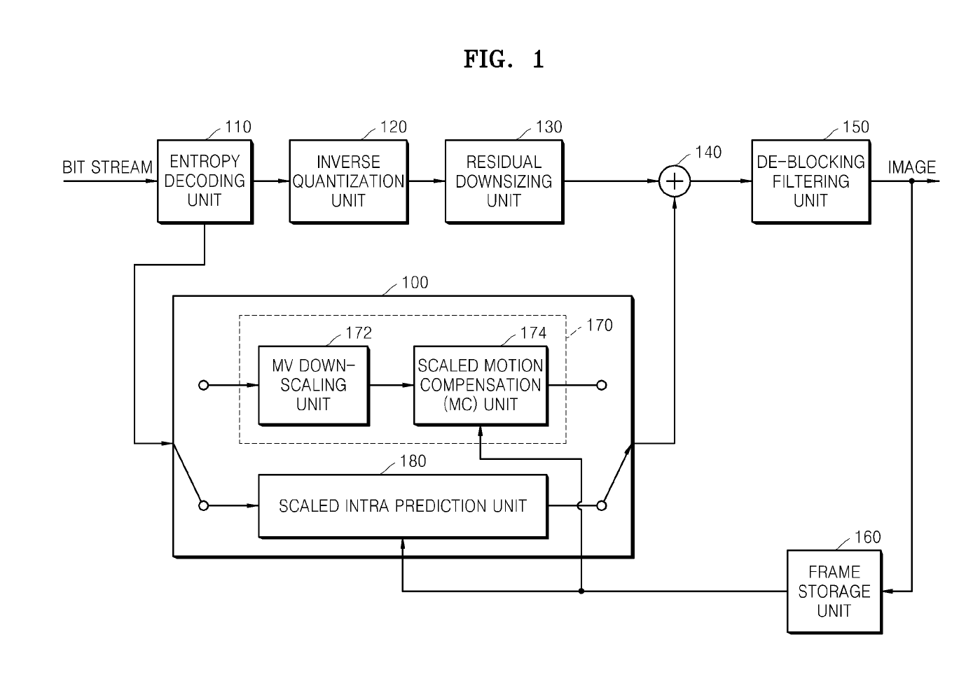

FIG. 1 is a block diagram of an image decoding apparatus according to an exemplary embodiment.

Referring to FIG. 1, the image decoding apparatus may be a compression decoder, such as an H.264 decoder, which supports an embedded scaling (ES) operation.

The image decoding apparatus includes an entropy decoding unit 110, an inverse quantization unit 120, a residual downsizing unit 130, an adding unit 140, a de-blocking filtering unit 150, a frame storage unit 160, and an image prediction unit 100.

The entropy decoding unit 110 entropy-decodes an input bit stream and extracts residual block information, motion vector (MV) information, and prediction mode information (inter/intra mode information). The residual block information is obtained by subtracting a prediction block from a current block.

The inverse quantization unit 120 inversely quantizes the residual block information extracted from the entropy decoding unit 110 and extracts a plurality of residual block coefficients.

The residual downsizing unit 130 down-scales the residual block coefficients extracted from the inverse quantization unit 120 and inversely transforms the down-scaled residual block coefficients to a residual signal. Thus, the residual downsizing unit 130 generates a residual image having a low resolution, thereby reducing the complexity of an inverse-transformation. The inverse-transformation may be an inverse discrete cosine transform (IDCT).

According to another exemplary embodiment, the residual downsizing unit 130 inversely transforms the residual block coefficients to the residual signal and down-scales the inversely transformed residual block coefficients.

The adding unit 140 generates an image signal reconstructed by adding the residual signal generated by the residual downsizing unit 130 to an inter prediction signal or an intra prediction signal generated by the image prediction unit 170.

The adding unit 140 combines the prediction signal and the residual signal and restores an image of a low resolution.

The de-blocking filtering unit 150 performs filtering so as to remove a blocking effect of the image signal reconstructed by the adding unit 140 and outputs a filtered image signal.

The frame storage unit 160 stores the image output by the de-blocking unit 150 in a frame unit.

The image prediction unit 100 selectively performs inter prediction and intra prediction that are scaled according to the prediction mode information (inter/intra mode information) generated by the entropy decoding unit 110.

In more detail, the image prediction unit 100 includes an inter prediction unit 170 and a scaled intra prediction unit 180.

The inter prediction unit 170 includes a MV down-scaling unit 172 and a scaled motion compensation (MC) unit 174.

The MV down-scaling unit 172 down-scales the MV generated by the entropy decoding unit 110.

The scaled MC unit 174 performs MC by using the MV down-scaled by the MV down-scaling unit 172 and image data stored in the frame storage unit 160. Thus, the scaled MC unit 174 generates a prediction image of a low resolution by using the down-scaled MV, thereby reducing the complexity of an MC module.

The scaled intra prediction unit 180 performs scaled intra prediction by using spatial information of scaled peripheral blocks stored in the frame storage unit 160.

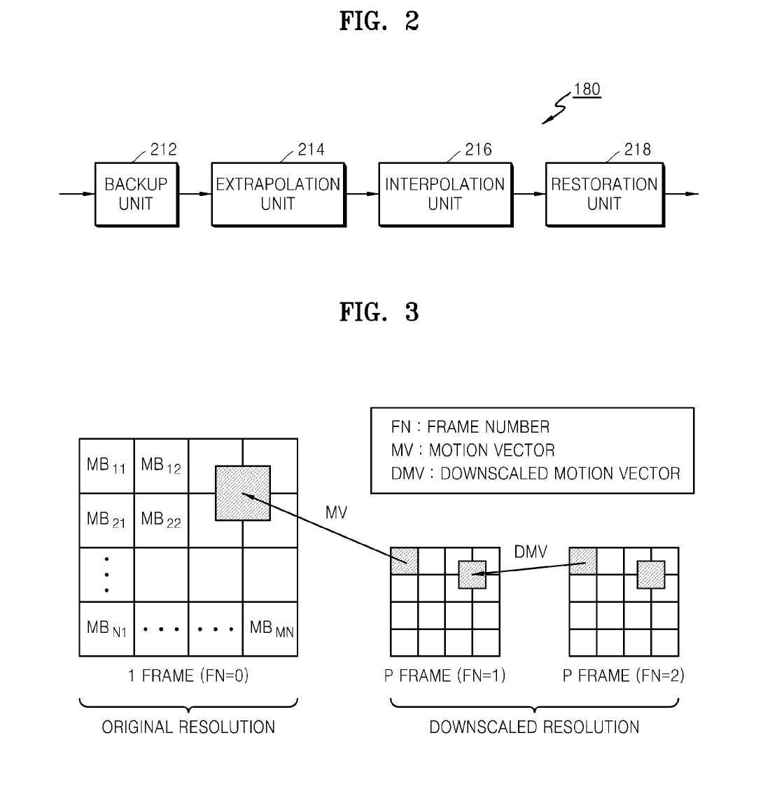

FIG. 2 is detailed block diagram of the scaled intra prediction unit 180 of FIG. 1.

Referring to FIG. 2, the scaled intra prediction unit 180 includes a backup unit 212, an extrapolation unit 214, an interpolation unit 216, and a restoration unit 218.

The backup unit 212 backs up values of boundary pixels of a block that is to be decoded by using an image frame stored in the frame storage unit 160.

The extrapolation unit 214 corrects the values of boundary pixels of the block that is to be decoded by using differences between the boundary pixels of the block that is to be decoded that was backed up in the backup unit 212 and pixels adjacent to the boundary pixels.

The interpolation unit 216 predicts a block that is to be decoded for each intra mode by using the values of boundary pixels corrected by the extrapolation unit 214. In this regard, the interpolation unit 216 predicts a pixel value down-scaled for each intra mode that is defined, for example, by standard by using the values of boundary pixels corrected by the extrapolation unit 214.

The restoration unit 218 restores the values of boundary pixels of the block that is to be decoded backed up by the backup unit 212 to replace the corrected values of boundary pixels with the values of boundary pixels of the block that is to be decoded.

FIG. 3 illustrates an MC performed by the scaled MC unit 174 of FIG. 1.

An MV of an original resolution is down-scaled, and an image of the down-scaled resolution is predicted by using a down-scaled image and a down-scaled MV.

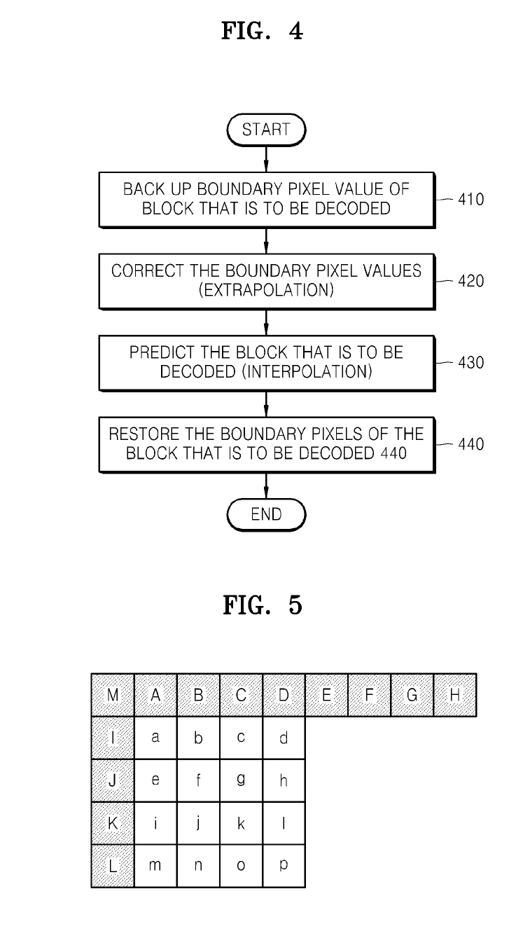

FIG. 4 is a flowchart illustrating an image intra prediction method according to an exemplary embodiment.

Referring to FIG. 4, if a bit stream is input, values of boundary pixels of a block that is to be decoded are backed up so as to maintain values of pixels of a previously decoded block (operation 410). The values of boundary pixels of the block that is to be decoded are down-scaled values.

Thereafter, the values of boundary pixels of the block that is to be decoded are corrected by using correlations between the backed-up values of boundary pixels of the block that is to be decoded and pixels adjacent to the boundary pixels (operation 420).

An extrapolation used to correct the values of boundary pixels of the block that is to be decoded will now be described in more detail.

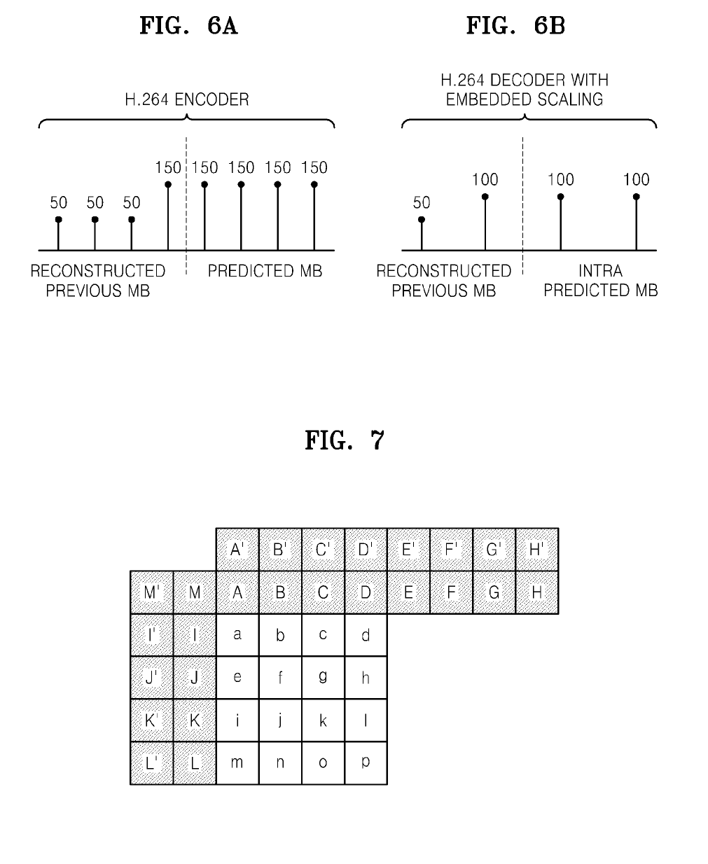

An intra prediction method proposed by a related art H.264 standard predicts pixel values a˜p of a block that is to be decoded by using pixel values A˜M of a previously decoded peripheral macroblock, as shown in FIG. 5. For example, if an intra prediction mode is a diagonal down-right mode, the pixel value d is calculated by using an equation (B/4+C/2+D/4). However, since the pixel values A˜M of the previously decoded peripheral macroblock are already down-scaled by using an ES technology, the pixel values A˜M are different from those of peripheral macroblocks used by an encoder to perform intra prediction. That is, as shown in FIG. 6A, a related art H.264 encoder predicts pixel values 150 of a macroblock by using pixel values 50 of a previously reconstructed macroblock. However, as shown in FIG. 6B, since an H.264 decoder with the ES technology performs intra prediction by using pixel values 100 of a previously down-scaled macroblock, the H.264 decoder with the ES technology predicts the pixel values 100 different from the pixel values 150 used by the encoder to perform intra prediction. In this regard, a prediction error value may be 50, obtained by subtracting the down-scaled pixel values 100 from the boundary pixel values 150.

Therefore, a related art intra prediction method causes erroneous prediction on a screen, which seriously deteriorates image quality.

In the present exemplary embodiment, values of boundary pixels of a block that is to be decoded are predicted by using a trend of values of pixels adjacent to the boundary pixels of the block that is to be decoded.

As shown in FIG. 7, when the pixel values a˜p of the block that is to be decoded are calculated during intra prediction, the pixel values A˜M of the macroblock peripheral to the pixel values a˜p of the block that is to be decoded are adjusted by using the pixel values A˜M of the macroblock and pixel values A′˜M′ adjacent to the pixel values A˜M of the macroblock. That is, a pixel value A* of a peripheral block corrected by using the pixel value A and the pixel value A′ adjacent to the pixel value A is calculated according to Equation 1 below:

$${A}^{*} = ( \begin{matrix}A + α ( A - {A}^{*} ) , & \vert A - {A}^{′} \vert > β \\ A , & else\end{matrix} \qquad [ Equation 1 ]$$

wherein, α and β may be experimentally defined as 0.25 and 30, respectively.

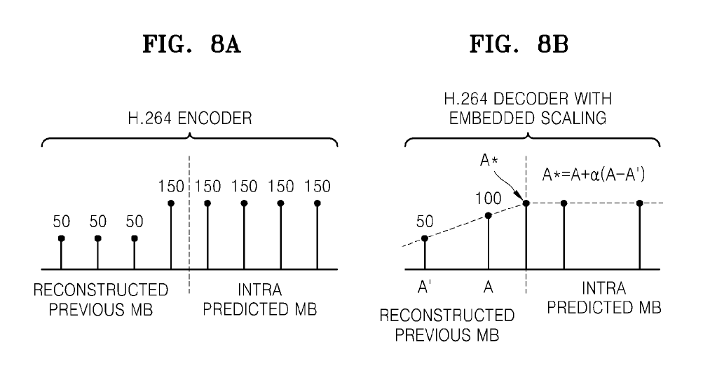

If the corrected pixel value A* of the peripheral block obtained by using the extrapolation of the present exemplary embodiment is used to perform intra prediction, as shown in FIG. 8B, an H.264 decoder with the ES may obtain pixel values approaching the pixel values 150 predicted by an H.264 encoder of FIG. 8A. The approaching pixel values may be obtained as 100+Δ. In this regard, Δ=α(A−A′).

Therefore, new pixel values corresponding to the pixel values A*˜M* of the peripheral block that are corrected by using the pixel values A˜M of the macroblock and the pixel values A′˜M′ adjacent to the pixel values A˜M of the macroblock are generated.

Referring back to FIG. 4, the block that is to be decoded for each intra mode is predicted based on the corrected pixel values A*˜M* of the peripheral block (operation 430).

An interpolation used to predict the block that is to be decoded will now be described in more detail.

For example, an H.264/AVC intra prediction method predicts a block in a frame by using information contained in the same frame, and provides four 16×16 prediction modes and nine 4×4 prediction modes for a luminal signal, and four 8×8 prediction modes for a chrominance signal.

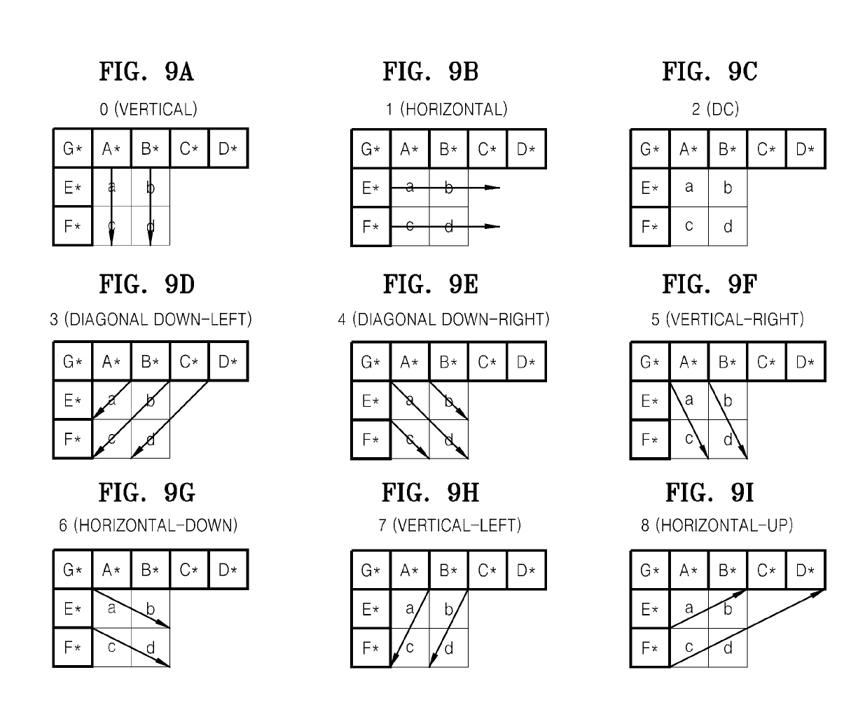

FIGS. 9A through 9I illustrate prediction directions for intra modes according to an exemplary embodiment.

Referring to FIGS. 9A through 9I, intra prediction of a 4×4 block includes a vertical prediction mode (mode 0), a horizontal prediction mode (mode 1), a DC prediction mode (mode 2), a diagonal down-left prediction mode (mode 3), a diagonal down-right prediction mode (mode 4), a vertical-right prediction mode (mode 5), a horizontal-down prediction mode (mode 6), a vertical-left prediction mode (mode 7), and a horizontal-up prediction mode (mode 8). Arrows indicate prediction directions for the 4×4 block. Mode 2 is a DC prediction mode having no direction and is not indicated by arrows. A*˜G* denote corrected pixel values of a peripheral block (hereinafter referred to as “boundary values”). a˜d denote prediction pixels.

If the intra prediction mode of the present exemplary embodiment is the DC prediction mode, the horizontal prediction mode, and the vertical prediction mode, a corresponding block is predicted by using the corrected boundary values obtained by using the extrapolation described above. Meanwhile, if the intra prediction mode of the present exemplary embodiment is the diagonal prediction mode, it may be problematic that coefficients used to predict pixel values of a current block that is to be decoded are used as the corrected boundary values.

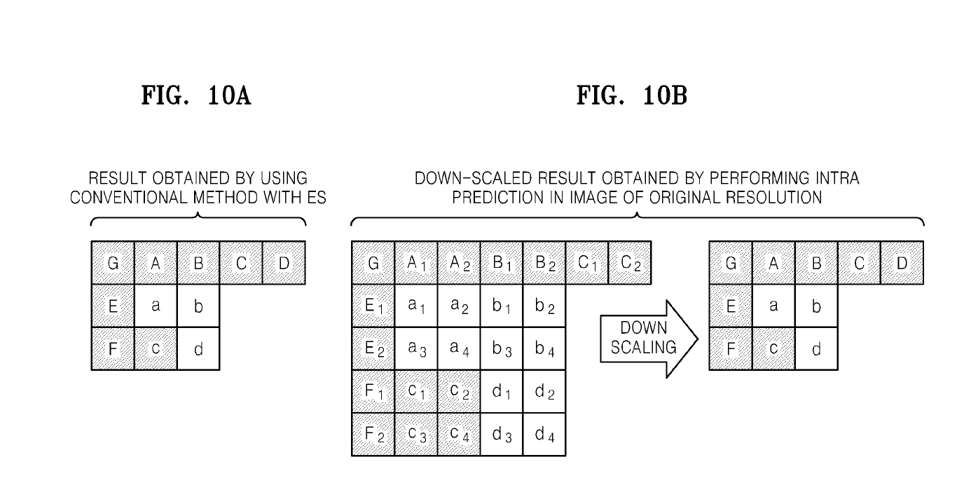

When the intra prediction mode is the diagonal down-right prediction mode, a value obtained by using the intra prediction method of the H.264 with ES, as shown in FIG. 10A, and a down-scaled value obtained by performing intra prediction in a block of an original size, as shown in FIG. 10B, are different from each other.

For example, if the intra prediction mode is the diagonal prediction mode, a down-scaled prediction pixel value c is an average of c₁, c₂, c₃, and c₄. If c₁, c₂, c₃, and c₄ are obtained according to the H.264 standard, c₁=E1/4+E2/2+F1/4, c₂=G/4+E1/2+E2/4, c₃=E2/4+F1/2+F2/4, and c₄=c₁. As a result, c=(c₁+c₂+c₃+c₄)/4=(G+4E₁+6E₂+4F₁+F₂)/16=(G+10E+5E)/16.

However, the prediction pixel value c obtained by using the intra prediction method of the related art H.264 standard with the ES is equal to (G1+2E+F)/4.

Therefore, as shown in FIGS. 9A-9I, the prediction pixels a˜d can be calculated by using the corrected boundary values A*˜G* in the prediction modes below:
1) Vertical prediction mode: a=c=A*, b=d=B* (the same as the related art intra prediction method)
2) Horizontal prediction mode: a=b=E*, c=d=F* (the same as the related art intra prediction method)
3) DC prediction mode: a=b=c=d=(A*+B*+C*+D*)/4 (the same as the related art intra prediction method)
4) Diagonal Down-Left prediction mode: a=(5A*+10B*+C*)/16, b=c=(5B*+10C*+D*)/16, d=(5C*+11D*)/16
5) Diagonal Down-Right prediction mode: a=d=(A*+2 G*+1E*)/4, b=(G*+10A*+5B*)/16, c=(G*+10E*+5F*)/16
6) Vertical-Right prediction mode: a=(E*+5G*+10A*)/16, b=(6A*+10B*)/16, c=(F*+7E*+5G*+3A*)/16, d=(G*+12A*+3B*)/16
7) Horizontal-Down prediction mode: a=(10E*+5G*+A*)/16, b=(3E*+5G*+7A*+B*)/16, c=(6E*+10F*)/16, d=(G*+12E*+3F*)/16
8) Vertical-Left prediction mode: a=(10A*+6B*)/16, b=(10B*+6C*)/16, c=(3A*+12B*+C*)/16, d=(3B*+12C*+D*)/16
9) Horizontal-Up prediction mode: a=(10E*+6F*)/16, b=(3E*+13F*)/16, c=d=F*

In summary, the present exemplary embodiment provides an image prediction method for each intra mode so as to exactly perform intra prediction on a down-scaled image, as shown in FIGS. 9A-9I. That is, an intra prediction process of a block that is to be decoded predicts pixels by using a standard compression method when an intra mode is a DC mode, a horizontal mode, and a vertical mode, and predict pixels by using an average of pixel values predicted by using the standard compression method when the intra mode is a diagonal left/right mode, a vertical left/right mode, and a horizontal left/right mode.

Further, to select an optimal intra prediction mode, encoding is performed for all defined intra prediction directions, a rate-distortion cost (RD cost) is calculated for intra prediction modes, and an intra prediction mode having a smallest RD cost is selected.

Referring back to FIG. 4, the backed-up values of boundary pixels of the block that is to be decoded are restored to the original values of boundary pixels changed by the extrapolation and interpolation (operation 440). For example, as shown in FIG. 7, new pixel values A*˜M* replace the original pixel values A˜M.

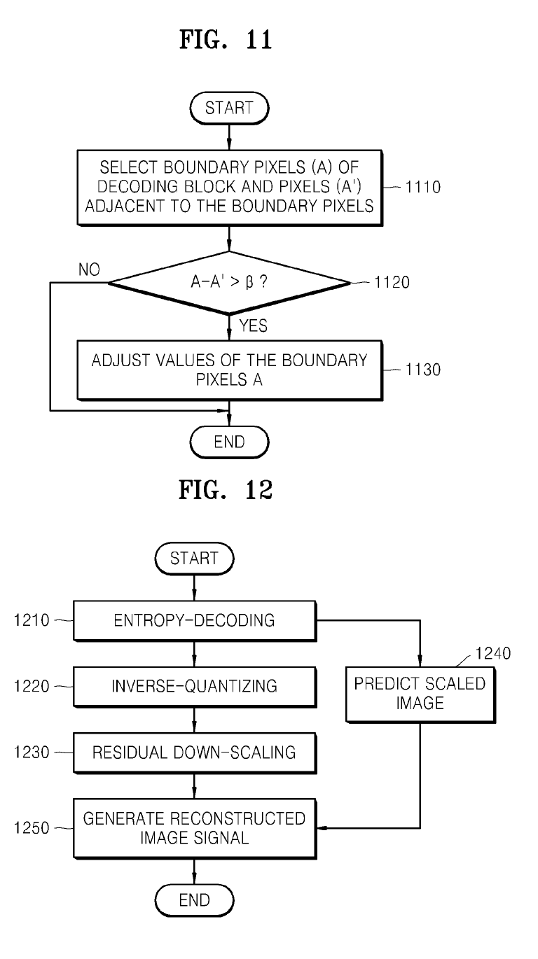

FIG. 11 is a detailed flowchart illustrating a method of correcting values of boundary pixels of a block that is to be decoded according to an exemplary embodiment.

Referring to FIG. 11, the boundary pixels (referred to as A) of the block that is to be decoded and pixels (referred to as A′) adjacent to the boundary pixels are selected (operation 1110).

Thereafter, the boundary pixels A of the block that is to be decoded and the pixels A′ adjacent to the boundary pixels are compared with each other (operation 1120). That is, differences between the boundary pixels A of the block that is to be decoded and the pixels A′ adjacent to the boundary pixels are calculated.

Thereafter, if the differences between the boundary pixels A of the block that is to be decoded and the pixels A′ adjacent to the boundary pixels are greater than a threshold β, values of the boundary pixels A are adjusted (operation 1130). If the differences between the boundary pixels A of the block that is to be decoded and the pixels A′ adjacent to the boundary pixels are smaller than the threshold β, the values of the boundary pixels A are maintained. The threshold β is previously set as an optimal value experimentally.

Thus, the values of the boundary pixels are corrected according to a result of comparing the boundary pixels A of the block that is to be decoded and the pixels A′ adjacent to the boundary pixels.

FIG. 12 is a flowchart illustrating an image decoding method according to an exemplary embodiment.

Referring to FIG. 12, residual block information, an MV, and prediction mode information are generated by entropy-decoding a bit stream (operation 1210).

Thereafter, residual block coefficients are extracted by inversely quantizing the generated residual block information (operation 1220).

The generated residual block coefficients are down-scaled (operation 1230).

Intra prediction scaled based on values of boundary pixels of a block that is to be decoded, the values being corrected by using correlations between the boundary pixels and pixels adjacent to the boundary pixels, is performed (operation 1240).

An image signal reconstructed by adding a residual signal to an intra prediction signal is generated (operation 1250).

Therefore, according to an exemplary embodiment, a compression decoder, such as an H.264 decoder, which supports an ES operation efficiently performs intra prediction, thereby increasing the quality of an image that is to be decoded. Further, the intra prediction method according to an exemplary embodiment may be applied to an I-frame for extracting a thumbnail of an image and an H.264 based ES image as well.

Exemplary embodiments may also be embodied as computer-readable codes on a computer-readable recording medium. The computer-readable recording medium may be any data storage device that may store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion.

While exemplary embodiments have been particularly shown and described above, it will be understood by one of ordinary skill in the art that various changes in form and details may be made therein without departing from the spirit and scope of the present inventive concept as defined by the following claims. The exemplary embodiments should be considered in descriptive sense only and not for purposes of limitation. Therefore, the scope of the inventive concept is defined not by the detailed description of the exemplary embodiments, but by the appended claims, and all differences within the scope will be construed as being included in the present inventive concept.

What is claimed is:

1. An image intra prediction method comprising:
backing up values of boundary pixels adjacent to a block that is to be decoded;
correcting the values of the boundary pixels adjacent to the block that is to be decoded based on correlations between the boundary pixels adjacent to the block that is to be decoded and pixels adjacent to the boundary pixels, outside of the block that is to be decoded;
predicting the block that is to be decoded according to an intra mode, from among a plurality of intra modes, based on the corrected values of the boundary pixels; and
restoring the values of the boundary pixels from the backed up values of the boundary pixels.

2. The method of claim 1, wherein the correcting the values of the boundary pixels comprises:
comparing the boundary pixels with the pixels adjacent to the boundary pixels; and
adjusting the values of the boundary pixels according to a result of the comparing.

3. The method of claim 2, wherein the adjusting the values of boundary pixels comprises:
obtaining differences between the boundary pixels and the pixels adjacent to the boundary pixels;
if the obtained differences between the boundary pixels and the pixels adjacent to the boundary pixels are greater than a threshold value, adjusting the values of the boundary pixels; and
if the obtained differences between the boundary pixels and the pixels adjacent to the boundary pixels are smaller than the threshold value, maintaining the values of the boundary pixels.

4. The method of claim 1, wherein the predicting the block that is to be decoded comprises predicting pixel values down-scaled for the intra mode by using the corrected values of the boundary pixels.

5. The method of claim 1, wherein the predicting the block that is to be decoded comprises:
predicting pixel values by using a standard compression method when the intra mode is one of a DC mode, a horizontal mode, and a vertical mode; and
predicting the pixel values by using an average of the pixel values predicted by using the standard compression method when the intra mode is one of a diagonal left/right mode, a vertical left/right mode, and a horizontal left/right mode.

6. The method of claim 1, wherein the restoring the values of boundary pixels comprises replacing the corrected values of the boundary pixels with the backed up values of the boundary pixels.

7. The method of claim 1, wherein the backed-up values of the boundary pixels are down-scaled pixel values.

8. The method of claim 1, wherein the image intra prediction is performed by a compression decoder for supporting an embedded scaling (ES) operation.

9. The method of claim 1, wherein the intra prediction mode is selected from among the plurality of intra prediction modes according to rate-distortion (RD) costs calculated for the plurality of intra prediction modes.

10. The method of claim 1, wherein the plurality of intra prediction modes comprises a vertical prediction mode, a horizontal prediction mode, a DC prediction mode, a diagonal down-left prediction mode, a diagonal down-right prediction mode, a vertical-right prediction mode, a horizontal-down prediction mode, a vertical-left prediction mode, and a horizontal-up prediction mode.

11. An image decoding method comprising:
generating residual block information, a motion vector (MV), and prediction mode information by entropy-decoding a bit stream;
extracting residual block coefficients by inversely quantizing the generated residual block information;
down-scaling the generated residual block coefficients;
performing intra prediction scaled based on corrected values of boundary pixels adjacent to a block that is to be decoded, corrected by using correlations between the boundary pixels and pixels adjacent to the boundary pixels, outside of the block that is to be decoded; and
generating an image signal reconstructed by adding a residual signal generated by the down-scaling to an intra prediction signal generated by the performing the intra prediction.

12. The method of claim 11, wherein the performing the intra prediction comprises predicting the block that is to be decoded according to an intra mode, from among a plurality of intra modes, based on the corrected values of the boundary pixels.

13. An image intra prediction apparatus comprising:
an image backup unit which backs up values of boundary pixels adjacent to a block that is to be decoded;
an extrapolation unit which corrects the values of the boundary pixels adjacent to the block that is to be decoded based on correlations between the boundary pixels adjacent to the block that is to be decoded and pixels adjacent to the boundary pixels, outside of the block that is to be decoded;
an interpolation unit which predicts a block that is to be decoded according to an intra mode, from among a plurality of intra modes, based on the corrected values of the boundary pixels; and
an image restoration unit which replaces the corrected values of the boundary pixels with the backed up values of the boundary pixels.

14. An image decoding apparatus comprising:
an entropy decoding unit which generates residual block information, a motion vector (MV), and prediction mode information by entropy-decoding a bit stream;
an inverse-quantization unit which extracts residual block coefficients by inversely quantizing the residual block information generated by the entropy decoding unit;
a residual down-sizing unit which down-scales the generated residual block coefficients generated by the inverse-quantization unit;
an image prediction unit which performs intra prediction scaled based on values of boundary pixels adjacent to a block that is to be decoded corrected by using correlations between the boundary pixels and pixels adjacent to the boundary pixels, outside of the block that is to be decoded; and
an adding unit which reconstructs an image signal by adding a residual signal generated by the residual down-sizing unit to an intra prediction signal generated by the image prediction unit.

15. The image decoding apparatus of claim 14, wherein the image prediction unit comprises:
an image backup unit which backs up values of the boundary pixels adjacent to the block that is to be decoded;
an extrapolation unit which corrects the values of the boundary pixels adjacent to the block that is to be decoded based on correlations between the boundary pixels and the pixels adjacent to the boundary pixels;
an interpolation unit which predicts the block that is to be decoded according to an intra mode, from among a plurality of intra modes, based on the corrected values of the boundary pixels; and
an image restoration unit which replaces the corrected values of the boundary pixels with the backed up values.

16. An image intra prediction method comprising:
obtaining corrected values of boundary pixels adjacent to a block that is to be decoded, the corrected values being based on correlations between the boundary pixels and pixels adjacent to the boundary pixels, outside of the block that is to be decoded; and
predicting the block that is to be decoded according to an intra mode, from among a plurality of intra modes, based on the obtained corrected values.

17. A computer readable recording medium storing a program for executing a method of claim 1.

18. A computer readable recording medium storing a program for executing a method of claim 11.

19. A computer readable recording medium storing a program for executing a method of claim 16.
